(19) United States
(12) Patent Application Publication
(10) Pub. No.: US 2010/0318510 A1
(43) Pub. Date: Dec. 16, 2010

(54) METHOD FOR ATTACHING TAG TO IMAGE OF PERSON

(75) Inventor: Jung-hee Ryu, Seoul (KR)

Correspondence Address: HUSCH BLACKWELL LLP, 190 Carondelet Plaza, Suite 600, ST. LOUIS, MO, 63105, US

(73) Assignee: OLAWORKS, INC., Seoul (KR)

(21) Appl. No.: 12/526,282

(22) PCT Filed: Feb. 5, 2008
(86) PCT No.: PCT/KR08/00755

§ 371 Date: Aug. 7, 2009

(30) Foreign Application Priority Data
Feb. 8, 2007 (KR) 10-2007-0013038

(51) Int. Cl. G06F 17/30

(52) U.S. Cl. 707/722; 707/E17.019

(57) ABSTRACT

A method for attaching tag information to an image of a person, includes the steps of: acquiring an image of a certain person; retrieving from a database a plurality of candidates having top N probabilities of being determined as the certain person and displaying the retrieved candidates on a screen of a terminal; providing a user with a pointing service capable of selecting a specific candidate among the displayed candidates; and attaching one or more tags to the image of the certain person by using tag information having been attached about the specific candidate who is selected by the user by the pointing service. As a result, the GUI may be provided to a mobile phone, capable of assisting the user to tag the image of the certain person easily. Therefore, the image of the certain person can be easily classified and searched by using the tag attached thereto.

### TECHNICAL FIELD

The present invention relates to a method for tagging an image of a person with ease.

### BACKGROUND ART

In recent years, much research has been conducted on image search methods, among which the search of an image of a person (a portrait) is of a great use and, for this search service, it is necessary to adequately tag an image of a person. For example, the tagging information on an image of a certain person may include not only a name of the certain person but also a nickname, a mail address of the certain person and the like.

The tendency toward digital convergence provides various multimedia functions to a mobile phone or other portable devices, which may have small-sized keys so that it is difficult to input various texts by manipulating the keys. For example, in case of the mobile phone, twelve keys may be used to input English, Korean, numbers, special characters and the like.

Even though the tagging information on an image may be variously determined in general, the tagging information on an image of a person may be restrictively determined. For example, the tagging information, e.g., the name, the nickname and other information on a certain person included in the image, attached to the image, may be used to classify and search the image with ease.

### DISCLOSURE OF INVENTION

### Technical Problem

In order to easily classify an image of a person, a technique for tagging the image of the person may be required. To this end, it is also necessary to develop a Graphic User Interface (GUI), capable of helping a user to tag the image of a person in comfort.

### Technical Solution

It is, therefore, one object of the present invention to provide a user-friendly Graphic User Interface (GUI) capable of helping a user to tag an image of a person with ease.

### Advantageous Effects

In accordance with exemplary embodiments of the present invention, there is provided the GUI of a mobile phone or other portable devices, capable of easily assisting a user to tag an image of a person. The image of the person can be easily classified and searched by using the tag attached thereto.

### BRIEF DESCRIPTION OF THE DRAWINGS

The above and other objects and features of the present invention will become apparent from the following description of preferred embodiments given in conjunction with the accompanying drawings, in which:

FIG. 1 shows a flow chart of a method for tagging an image of a person in accordance with a first embodiment of the present invention;

FIG. 2 illustrates a part of a process included in the method in accordance with the first embodiment;

FIG. 3 provides the images of the N candidates in accordance with the first embodiment;

FIG. 4 depicts a flow chart showing a method for tagging an image of a person in accordance with a second embodiment of the present invention;

FIG. 5 provides a flow chart showing a method of tagging an image of a person in accordance with a third embodiment of the present invention;

FIG. 6 illustrates a part of the process included in the method in accordance with the third embodiment; and

FIG. 7 illustrates a part of the process included in the method in accordance with the third embodiment.

### BEST MODE FOR CARRYING OUT THE INVENTION

In accordance with one aspect of the present invention, there is provided a method for attaching tag information to an image of a person, including the steps of: acquiring an image of a certain person; retrieving from a database a plurality of candidates having top N probabilities of being determined as the certain person and displaying the retrieved candidates on a screen of a terminal; providing a user with a pointing service capable of selecting a specific candidate among the displayed candidates; and attaching one or more tags to the image of the certain person by using tag information having been attached about the specific candidate who is selected by the user by the pointing service.

In accordance with another aspect of the present invention, there is provided a method for attaching tag information to an image of a person, including the steps of: acquiring an image of a certain person; retrieving from a database a specific candidate having the highest probability of being determined as the certain person and displaying a name of the retrieved specific candidate near a facial region of the certain person on a screen of a terminal; retrieving from the database a plurality of next candidates having next highest probabilities of being determined as the certain person and displaying the retrieved candidates on the screen of the terminal; providing a user with a pointing service capable of selecting one among a candidate group including the specific candidate and the next candidates; and attaching one or more tags to the image of the certain person by using tag information having been attached about the selected one who is selected by the user by the pointing service.

### MODE FOR THE INVENTION

In the following detailed description, reference is made to the accompanying drawings that show, by way of illustration, specific embodiments in which the present invention may be practiced. These embodiments are described in sufficient detail to enable those skilled in the art to practice the present invention. It is to be understood that the various embodiments of the present invention, although different from one another, are not necessarily mutually exclusive. For example, a particular feature, structure, or characteristic described herein in connection with one embodiment may be implemented within other embodiments without departing from the spirit and scope of the present invention. In addition, it is to be understood that the location or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The present invention will now be described in more detail, with reference to the accompanying drawings.

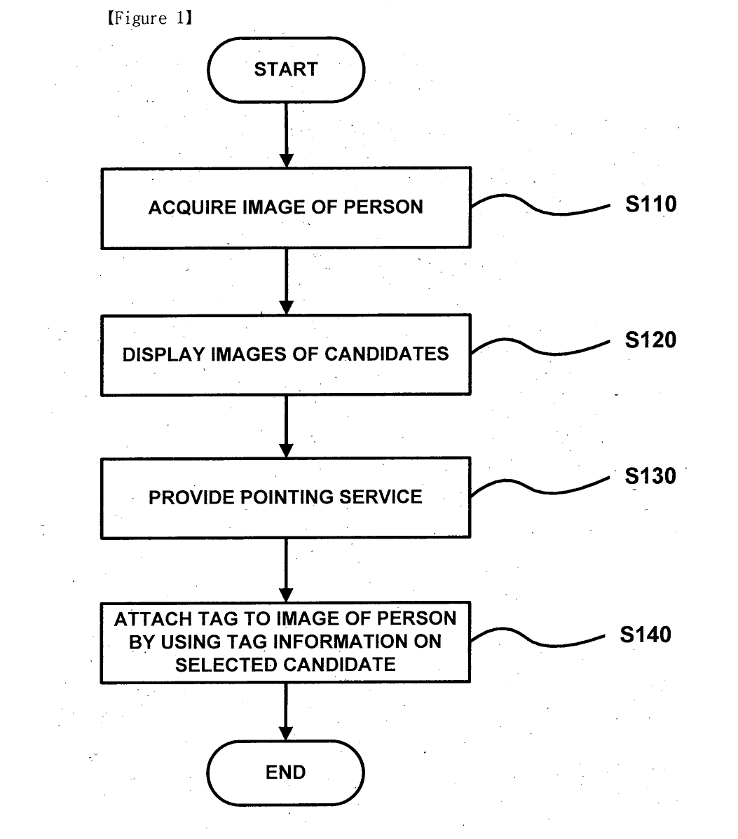

FIG. 1 shows a flow chart showing a method for tagging an image of a person in accordance with a first embodiment of the present invention.

A device for tagging an image of a person (hereinafter, referred to as ‘the tagging device’), e.g., a mobile phone or a portable device, acquires digital data including an image of a certain person in step S110. The digital data including the image of the certain person may be acquired by directly taking a picture of the certain person through a camera module built in the tagging device or by indirectly receiving it (or them) from other devices outside of the tagging device.

If the image of the certain person is acquired, the tagging device retrieves, from a database, a plurality of images of candidates having high probabilities of being determined as the certain person included in the acquired digital data and displays, e.g., the retrieved images of the candidates in step S120. A technique for providing a plurality of the candidates (i.e., Top N list), having the top N probabilities of being determined as the certain person included in the acquired digital data, is disclosed in Korean Patent Application No. 10-2006-0077416 filed on Aug. 17, 2006 (which was also filed in PCT international application No. PCT/KR2006/004494 on Oct. 31, 2006) by the same applicant as that of the present invention, entitled “Methods for Tagging Person Identification Information to Digital Data and Recommending Additional Tag by Using Decision Fusion”.

Herein, the database where the images of the candidates have been recorded may be included in the tagging device, but it may be provided outside of the tagging device. In the latter case, the tagging device may receive the images of the candidates from the database to display them.

After displaying the candidates, e.g., the images of the N candidates having the top N probabilities, the tagging device provides a user with a pointing service in step S130. The user may select a specific image among the images of the candidates by using the pointing service.

After the user selects the specific image, the tagging device may attach one or more appropriate tags to the image of the certain person included in the acquired digital data by referring to one or more tags having been attached to the selected image, in step S140. For example, if the tags having been attached to the selected image include a name, a nickname, or other information, the user may select the name or the nickname in order to attach one or more new tags to the image of the certain person included in the acquired digital data. Further, the tagging device may attach other information, such as a mail address, a phone number and the like, to the image of the certain person, as additional tags, if selected by the user.

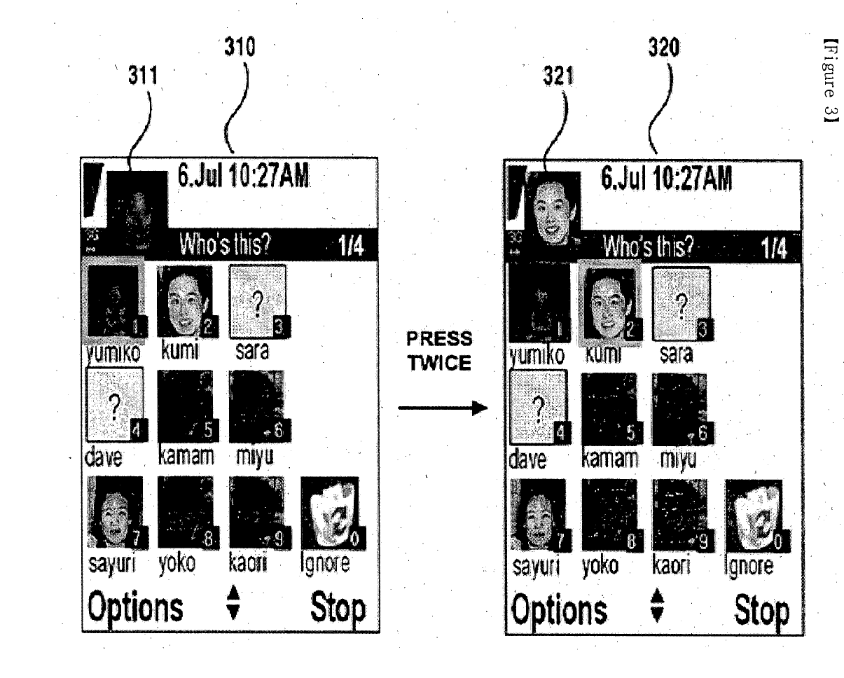

In case there are no images of some candidates stored in the database though they are included in the top N list, like Sara and Dave illustrated in FIG. 3, their names only may be displayed in the Top N list. They may be considered to have high probabilities of being determined as the certain person by referring to a life pattern, a text message, etc. thereof (See Korean Application No. 10-2006-0077416).

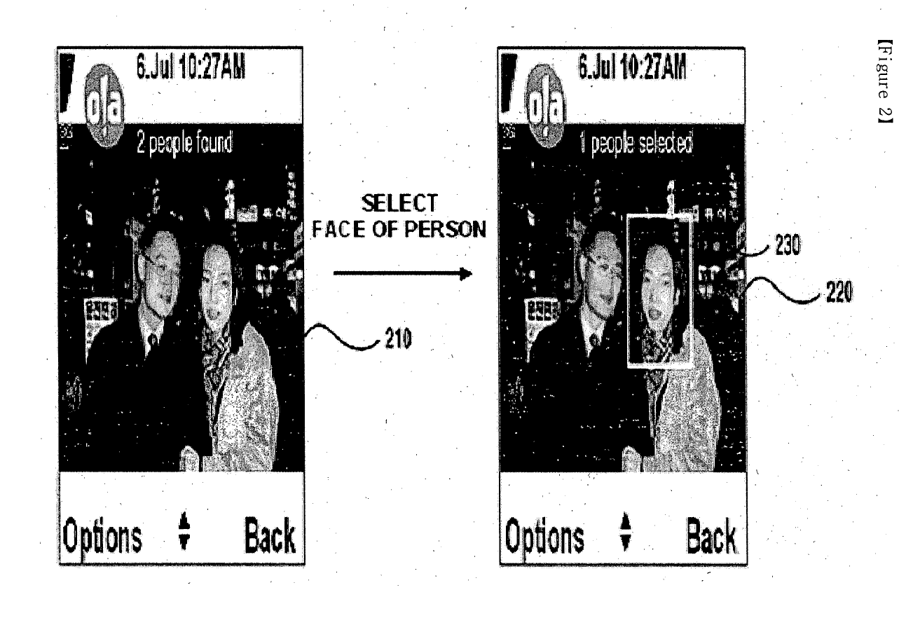

FIG. 2 illustrates a part of a process included in the method in accordance with the first embodiment.

If a plurality of persons are included in an acquired digital data 210, the tagging device may provide a user with GUI, capable of selecting one person 230 among the plurality of persons to easily and selectively attach tagging information on the person 230 to the digital data 210. If the person 230 is selected as shown in the picture in the right side of FIG. 2, tagging information on the person 230 may be attached to the digital data 210 by using the convenient GUI provided by the tagging device. In this case, images (and/or names) of top N candidates having the top N probabilities of being determined as the person 230 may be displayed to embody the simple tagging process (Refer to FIG. 3). As described above, even if a plurality of persons are included in the image, the tagging device may provide the user with the GUI capable of selecting a specified candidate among the displayed candidates in order to easily attach tag information on the specified candidate to the image.

FIG. 3 provides the images of the N candidates in accordance with the first embodiment.

For example, as illustrated in FIG. 3, the images (and/or the names) of nine candidates may be displayed in the form of 3*3 matrix on a screen. Displaying the images of the candidates in the form of 3*3 matrix enables the user to more easily select a specific candidate, in case an input unit of a mobile phone or a portable device is a sort of a keypad. For example, if the keys corresponding to numerals 1 to 9 in the keypad of the mobile phone are arranged in the form of 3*3 matrix, there is a one-to-one correspondence between the displayed images of the nine candidates and the keys of the keypad, so that the user can easily select any candidate by pressing an appropriate key.

Further, if the keys in the keypad are arranged in the form of m*n matrix, the images of the candidates may be also displayed in the form of m*n matrix in order to achieve a one-to-one correspondence therebetween.

In the mean time, if no image of a person is included in the digital data or if an image of a thing is incorrectly recognized as an image of a person, the user may press, e.g., a ‘0’ key to ignore it.

As illustrated in FIG. 3, the images of the candidates may be displayed along with their names. For example, an image of a first candidate is displayed along with a name of “Yumiko.”

Moreover, as shown in a screen 310 of the tagging device, an image, e.g., the image of the first candidate, may be highlighted. Further, the image of the highlighted candidate may be also displayed in a separate region 311.

The tagging device provides the user with the pointing service so that the user can select any one of the displayed images of the candidates. That is, the user can change the location of the highlighted region by manipulating the keys in order to select any one of the displayed images of the candidates. For example, if the user presses a ‘2’ key at the time when the image of the first candidate is highlighted, the location of the highlighted region may be moved to a second candidate (an image of the second candidate, i.e., “Kumi”, becomes highlighted). Referring to a screen 320 on which the image of the second candidate is highlighted, the image of the second candidate may be also displayed in a separate region 321.

As described above, the user can select one of the candidates by directly pressing the corresponding numerical key, or by moving the highlighted region by manipulating arrow keys provided to most mobile phones. For example, at the time when the image of the first candidate is highlighted, the user may move the highlighted region to the image of the second candidate by pressing the right arrow key.

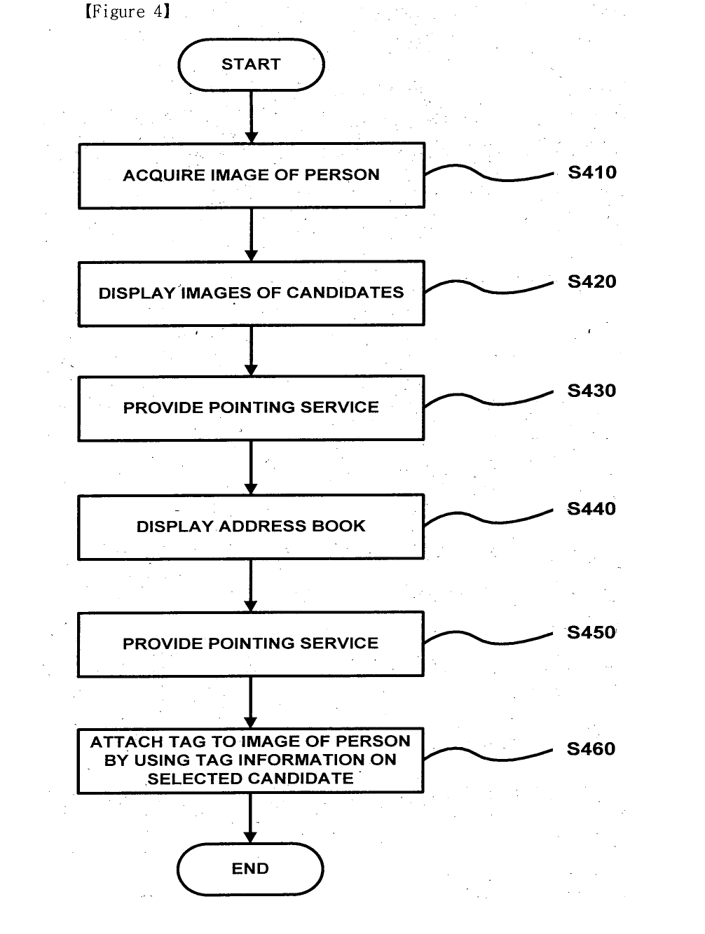

FIG. 4 depicts a flow chart showing a method for tagging an image of a person in accordance with a second embodiment of the present invention.

A tagging device, e.g., a mobile phone or a portable device, acquires digital data including an image of a certain person in step S410. As described in the method of tagging an image of a person as shown in FIG. 1, the digital data including the image of the certain person can be acquired by directly taking a picture of the certain person through a camera module built in the tagging device, or by indirectly receiving it (or them) from other devices outside of the tagging device.

If the digital data including the image of the certain person is acquired, the tagging device may retrieve from a database a plurality of candidates, e.g., N candidates having the top N probabilities of being determined as the certain person included in the acquired digital data and then displays the retrieved images (and/or names) of the candidates in step S420. The database where the images of the candidates have been recorded may be included in the tagging device, but it may be provided outside of the tagging device. In the latter case, the tagging device may receive the images (and/or the names) of the candidates from the database in order to display them.

After displaying the images (and/or the names) of the N candidates having the top N probabilities, the tagging device provides a user with a pointing service in step S430. The user can select a desired image among the images of the candidates by using the pointing service.

However, in case none of the displayed candidates is considered to be identical with the certain person, the tagging device may display images (and/or names) of a second group of N candidates having the next highest probabilities, i.e., from top (N+1) to top 2N probabilities.

In case a specific candidate among the second group of the N candidates is considered to be the certain person, the user may select the specific candidate by manipulating keys. However, in case none of the displayed second group of the N candidates is considered to be identical with the certain person, the tagging device may display images (and/or names) of a third group of N candidates having the next highest probabilities, i.e., from top (2N+1) to top 3N probabilities.

In case a specific candidate among the third group of the N candidates is considered to be the certain person, the user may select the specific candidate by manipulating keys.

Otherwise, images (and/or names) of a fourth group of N candidates, a fifth group of

N candidates etc. may be displayed for the choice.

However, in case none of the displayed candidates is considered to be the certain person even though all images of the candidates are retrieved, it is necessary to retrieve a desired person among the candidates registered only in an address book, a phone book and the like. In detail, the user may press, e.g., a ‘List’ button to refer to the address book in step S440. If the desired person is considered to be included in the address book, the tagging device provides the user with the pointing service in step S450, so that the user can select the desired person. However, if there is no desired person in the address book, the user may determine the certain person included in the acquired digital data as a new person who has not been registered in the tagging device, and press a specific button, e.g., a ‘New’ button, to input the information on the new person (i.e., the certain person). This manipulation of the keys may be applied to other embodiments even though any specific description thereabout is not presented.

If the user selects the desired person, the tagging device attaches tag information on the desired person to the acquired image of the certain person in step S460. For example, a name, a mail address, a phone number, etc. of the desired person may become the tag of the image of the certain person.

If the user attached an incorrect tag to the image of the certain person or wants to delete a tag, the user may press a specific button, e.g., an ‘Ignore’ button, to delete it. This manipulation of the keys may be also applied to other embodiments even though any specific description thereabout is not presented.

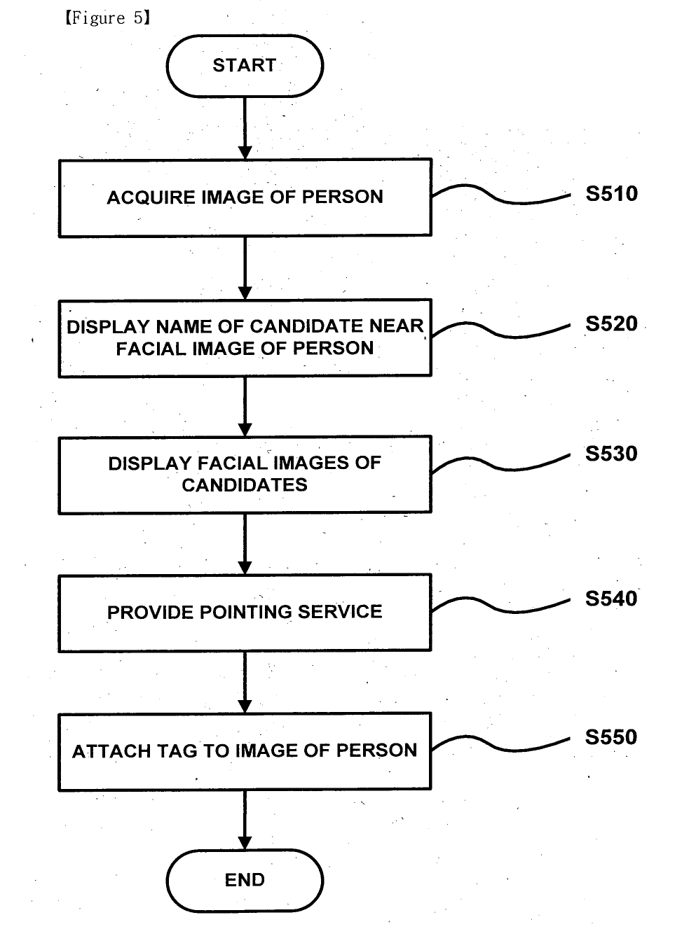

FIG. 5 provides a flow chart showing a method for tagging an image of a person in accordance with a third embodiment of the present invention.

A tagging device (for example, a mobile phone or a portable device) acquires digital data including an image of a certain person in step S510. As described in the embodiments of FIGS. 1 and 4, the digital data including the image of the certain person can be acquired by directly taking a picture of the person through a camera module built in the tagging device, or by indirectly receiving it (or them) from other devices outside of the tagging device.

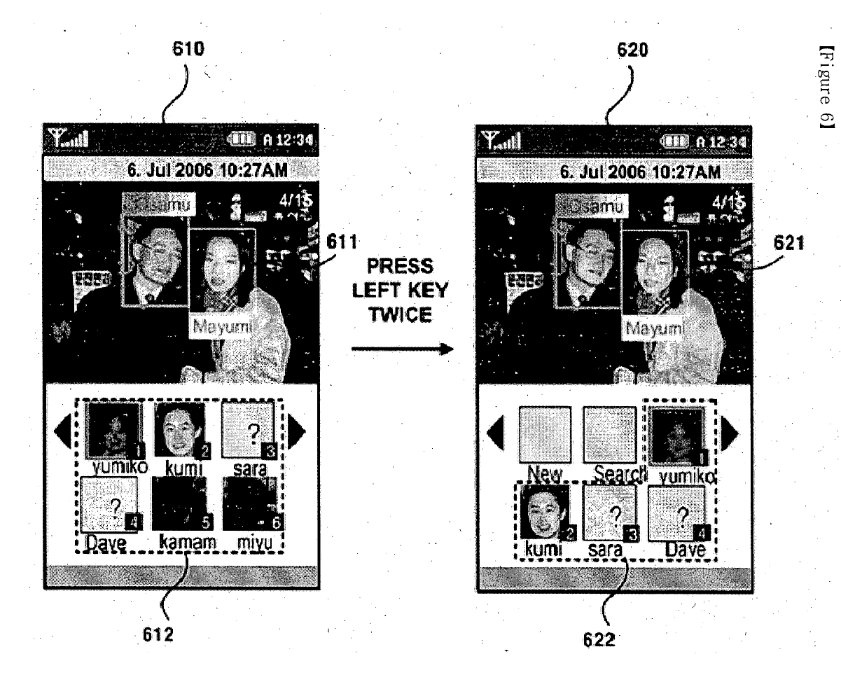

If the digital data including the image of the certain person is acquired, the tagging device retrieves, from a database, a candidate having a highest probability of being determined as the certain person included in the acquired digital data and displays the name of the retrieved candidate near a facial image of the certain person in step S520 (refer to “Mayumi” in FIG. 6). Herein, if the name displayed near the facial image is selected in the end, the name may be conveniently attached as a tag to the image of the certain person.

Moreover, the tagging device retrieves, from the database, M candidates having next highest probabilities of being determined as the certain person included in the acquired image and displays the M candidates below the acquired image in step S530 (refer to Yumiko, Kumi, Sara and the like in a region 612 of FIG. 6). If the name displayed near the facial image of the certain person in step S520 is considered to be incorrect, the user may select a desired one from the displayed M candidates in step S530. In accordance with another embodiment of the present invention, Mayumi, who has the highest probability of being determined as the certain person, may be displayed together with Yumiko and Kumi, in the region 612.

As described in the embodiments of FIGS. 1 and 4, the database may be provided either inside or outside the tagging device.

After displaying information, e.g., the name and/or the facial images, on the candidates in the region 612, the tagging device provides the user with a pointing service in step S540, so that the user can select a desired person among the candidates. In case the user selects the desired person by using the pointing service, the tagging device attaches tag information on the desired person to the acquired image of the certain person in step S550.

FIG. 6 illustrates a part of the process included in the method in accordance with the third embodiment.

Referring to a screen 610 of FIG. 6, the candidates having the high probabilities of being determined as each of the persons included in the acquired digital data are displayed. Herein, since there is no sufficient room for displaying nine candidates in the region 612 due to the space occupied by the acquired digital data, only six candidates can be displayed, unlike FIG. 3. That is, the images (and/or the names) of the six candidates may be displayed in the form of 2*3 matrix as shown in FIG. 6.

Further, the images (and/or the names) of the candidates may be displayed in the form of p*q matrix in accordance with another embodiment of the present invention. Herein, the arrangement of the images (and/or the names) of the candidates may satisfy a one-to-one correspondence with that of the keys.

Likewise, the tagging device may provide the user with the pointing service so that the user can select a desired candidate among the candidates.

To select the desired candidate among, e.g., the six candidates displayed in the region 612, the user may press the corresponding numerical key or move a highlighted region by manipulating arrow keys provided to the keypad. In case there is no desired candidate included in the displayed six candidates, the user can press the arrow keys to display other candidates. For example, an image (and/or a name) of another candidate may be provided from the bottom right side one by one, whenever the user presses, e.g., the right arrow key. Furthermore, an image (and/or a name) of the candidate of a high priority which has disappeared from the screen may appear on the screen one by one, whenever the user presses, e.g., the left arrow key. Herein, it should be noted that the functions of the left and the right arrow keys can be swapped.

In detail, in FIG. 6, there is provided a specific image of one man and one woman.

Hereinbefore, the description of the GUI has been focused on the tagging process about the woman whose facial area is highlighted, but the tagging process can also be applied to the man in the same manner if his facial area is highlighted.

Referring to FIG. 6, frames may be automatically set around the man's facial area and the woman's facial area. For example, if the user selects a right frame including the woman's face, to be tagged first by activating it by manipulating the keys, images and/or names of candidates, having high probabilities of being determined as the woman, are provided to help the user to easily attach one or more tags about the woman.

After completing the tagging process about the woman, the user may move a cursor to a left frame including the man's face to attach one or more tags about the man. Herein, if the cursor is moved to the left frame including the man's face, the candidates having high probabilities of being determined as the man may be provided to the region 612 so that the user can easily select a desired candidate.

Meanwhile, if the user presses, e.g., the left arrow key twice when the candidates having the top N probabilities are displayed on the screen 610 as shown in the left side of FIG. 6, the region 612 is changed into a region 622 as shown in the right side of FIG. 6. Herein, the user can select the ‘New’ key to give a new name to a face 621, as shown in the right side of FIG. 6.

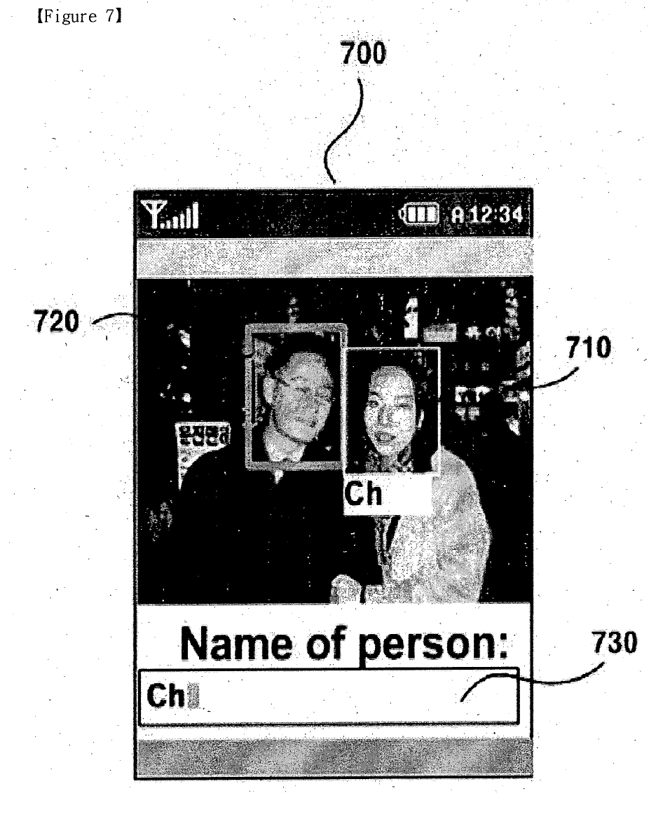

FIG. 7 illustrates a part of the process included in the method in accordance with the third embodiment.

Referring to FIG. 7, when the user presses the ‘New’ key, the region 622 where the images (and/or the names) of the candidates are displayed disappears from the screen, and instead, a region 730 for inputting a new name may be displayed on a screen 700. The user may insert the name of a person 710 by manually inputting the name in the region 730. Likewise, the user may insert the name of a person 720 by manually inputting the name in the region 730.

While the present invention has been shown and described with respect to the preferred embodiments, it will be understood by those skilled in the art that various changes and modifications may be made without departing from the spirit and the scope of the present invention as defined in the following claims.

1. A method for attaching tag information to an electronic image of a person, comprising the steps of:
acquiring an electronic image of a person;
retrieving from a database a plurality of candidates having top N probabilities of being determined as the person and displaying the retrieved candidates on a screen of a user, where N is an integer equal to or larger than 1;
providing the user with a pointing service capable of selecting a candidate among the displayed candidates; and
upon receipt of a selection of the candidate from the user, attaching one or more tags to the electronic image of the person by using tag information attached about the selected candidate.

2. The method of claim 1, wherein the step of acquiring the electronic image of the person comprises the step of specifying the person among a plurality of persons included in the electronic image.

3. The method of claim 1, wherein the step of displaying the retrieved candidates comprises the step of displaying images or names of the retrieved candidates.

4. The method of claim 1, wherein the step of displaying the retrieved candidates comprises the step of displaying the retrieved N candidates in the form of m*n matrix on the screen of the terminal such that the arrangement of the retrieved N candidates is one-to-one correspondence with the keys in the keypad in the terminal, if the keys of the keypad are arranged in the form of m*n matrix.

5. (canceled)

6. The method of claim 1, wherein the step of providing the user with the pointing service comprises the step of: moving a position of a highlighted region including one candidate among the N candidates by manipulating keys, until the highlighted region includes the candidate.

7. The method of claim 1, further comprising the steps of:
retrieving candidates from an address book and displaying the retrieved candidates by manipulating the key; and
providing the user with the pointing service capable of selecting the candidate among the retrieved candidates.

8. The method of claim 7, wherein, in case there is no candidate in the database, the candidates are retrieved from the address book.

9. The method of claim 8, wherein, in case there is no candidate in the address book, the person included in the acquired image is considered to be a new person who has not been registered in the database or the address book, and tag information for the certain person is manually inserted by manipulating keys.

10. The method of claim 1, wherein the tags attached to the electronic image of the person include at least one of a name, a nickname, an address, and a telephone number of the person.

11. The method of claim 1, wherein, in case the tags are incorrectly attached to the electronic image of the person, the tags are deleted by manipulating keys.

12. A method for attaching tag information to an electronic image of a person, comprising the steps of:
acquiring an electronic image;
retrieving from a database a candidate having the highest probability of being determined as a person and displaying a name of the retrieved candidate near a facial region of the person on a screen of a terminal;
retrieving from the database a plurality of next candidates having next highest probabilities of being determined as the person and displaying the retrieved candidates on the screen of the terminal;
providing a user with a pointing service capable of selecting one among a candidate group including the candidate and the next candidates; and
attaching one or more tags to the electronic image of the person by using tag information having been attached about the selected one who is selected by the user by the pointing service.

13. The method of claim 12, wherein the step of displaying the retrieved next candidates displays candidates having the top N probabilities of being determined as the person except the candidate having the highest probability.

14. The method of claim 12, wherein the step of displaying the retrieved next candidates displays candidates having the top N probabilities of being determined as the person including the candidate having the top 1 probability.

15. The method of claim 14, wherein the step of displaying the retrieved next candidates displays candidates in the form of p*q matrix below the acquired image.

16. The method of claim 15, wherein keys of a keypad in the terminal are arranged in the form of p*q matrix, and the arrangement of the displayed next candidates is one-to-one correspondence with that of the keys.

17. (canceled)

18. The method of claim 12, further comprising the steps of:
retrieving candidates from an address book and displaying the retrieved candidates by manipulating the key; and
providing the user with the pointing service capable of selecting one among the retrieved candidates.

19. The method of claim 18, wherein, in case there is no one selected in the database, the candidates are retrieved from the address book.

20. The method of claim 19, wherein, in case there is no one selected in the address book, the person included in the acquired image is considered to be a new person who has not been registered in the database or the address book, and tag information for the certain person is manually inserted by manipulating keys.

21. The method of claim 12, wherein the tags attached to the electronic image of the person include at least one of a name, a nickname, an address, and a telephone number of the person.

22. (canceled)

23. One or more computer-readable media having stored thereon a computer program that, when executed by one or more processors, causes the one or more processors to perform acts including:
acquiring an electronic image of a person;
retrieving from a database a plurality of candidates having top N probabilities of being determined as the person and displaying the retrieved candidates on a screen of a user, where N is an integer equal to or larger than 1;
providing the user with a pointing service capable of selecting a candidate among the displayed candidates; and
upon receipt of a selection of the candidate from the user, attaching one or more tags to the electronic image of the person by using tag information attached about the selected.
